(19) United States
(12) Patent Application Publication
(10) Pub. No.: US 2006/0031363 A1
(43) Pub. Date: Feb. 9, 2006

(54) Synchronizing access to shared resources in a multi-system mail infrastructure

(75) Inventor: Peter K. Lyons, Groton, MA (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/189,269

(22) Filed: Jul. 26, 2005

Related U.S. Application Data
(60) Provisional application No. 60/591,231, filed on Jul. 26, 2004.

(51) Int. Cl. G06F 15/16; G06F 15/173

(52) U.S. Cl. 709/206; 709/225

(57) ABSTRACT

Embodiments of the present invention address deficiencies of the art in respect to file locking for mail management systems and provide a method, system and computer program product for synchronizing access to shared resources in a multi-system mail infrastructure. In an embodiment of the invention, a method for synchronizing access to shared resources in a multi-system mail infrastructure can include attempting to exclusively access a file, and, responsive to successfully obtaining access to the file, performing message processing in the multi-system mail infrastructure and releasing exclusive access to the file when concluding the processing.

### CROSS-REFERENCE TO RELATED APPLICATIONS

This patent application claims the benefit under 35 U.S.C. § 119(e) of presently pending U.S. Provisional Patent Application 60/591,231, entitled SYNCHRONIZING ACCESS TO SHARED RESOURCES IN A MULTI-SYSTEM MAIL INFRASTRUCTURE, filed on Jul. 26, 2004, the entire teachings of which are incorporated herein by reference.

### BACKGROUND OF THE INVENTION

1. Field of the Invention

The present invention relates to file locking and more particularly to synchronizing access to shared resources through a file locking mechanism.

2. Description of the Related Art

Electronic mail, referred to in the art as e-mail, has proven to be the most widely used computing application globally. Though e-mail has been a commercial staple for several decades, due to the explosive popularity and global connectivity of the Internet, e-mail has become the preferred mode of asynchronous communications, regardless of the geographic separation of communicating parties. Today, more e-mails are processed in a single hour than phone calls. Clearly, e-mail as an asynchronous mode of communications has been postured to replace all other modes of communications excepting voice telephony.

Conventional e-mail processing involves the intermediate and long-term storage of messages in a data store of e-mail messages. For a single user system, managing the data store of e-mail messages can be as simple as managing a series of directory folders in a basic operating system. Larger, distributed corporate e-mail processing differs somewhat from more basic e-mail management systems in that multiple parties can access the functionality and data for the e-mail processing system. Accordingly, in the larger, corporate setting, e-mail messages can be disposed temporarily and permanently in a database management system which can be configured for a high volume transactional environment.

Large corporate e-mail and data processing demands can exceed the capabilities of even the most powerful computing systems. Of paramount importance, access to e-mail resources must be coordinated between different computing devices in order to avoid a race condition for accessing the same resource simultaneously by the different computing devices. Current solutions for coordination access to data between multiple machines include the use of file system file locks or database row locks. When using file system locks or database row locks, once a user access a resource, the resource can be locked from use by other users. Only when the accessing user releases the resource can the other users compete to access the resource.

Thus, using locks, one can achieve a level of synchronization between different computing devices to a shared resource. Notwithstanding, some high-level development platforms, specifically the standard input/output package of the Java environment, do not provide the necessary logic required for utilizing a file system file lock approach. By comparison, the database row lock approach for achieving synchronization has been shown to have very different characteristics depending upon the database product used. Accordingly, the database row lock approach heretofore has been unsuitable for many product deployments.

### BRIEF SUMMARY OF THE INVENTION

Embodiments of the present invention address deficiencies of the art in respect to file locking for mail management systems and provide a novel and non-obvious method, system and computer program product for synchronizing access to shared resources in a multi-system mail infrastructure. In an embodiment of the invention, a method for synchronizing access to shared resources in a multi-system mail infrastructure can include attempting to exclusively access a file, and, responsive to successfully obtaining access to the file, performing message processing in the multi-system mail infrastructure and releasing exclusive access to the file when concluding the processing.

Attempting to exclusively access the file can include attempting to delete a primary file, create a temporary file and rename the temporary file to the primary file. Attempting to exclusively access the file further can include writing a unique signature to the temporary file, opening a renamed version of the temporary file, and confirming that the opened renamed version of the temporary file contains the unique signature. Finally, the method can include, responsive to unsuccessfully failing to obtain access to the file, pausing before re-attempting to exclusively access a file. In this regard, the pausing can include pausing for a random period of time.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a data processing system configured for synchronizing access to shared resources in a multi-system mail infrastructure; and,

FIG. 2 is a flow chart illustrating a process for synchronizing access to shared resources in a multi-system mail infrastructure.

### DETAILED DESCRIPTION OF THE INVENTION

Embodiments of the present invention provide a method, system and computer program product for synchronizing access to shared resources in a multi-system mail infrastructure. Specifically, the present invention defines a mechanism whereby multiple machines processing the same mail delivery workload can coordinate access to the workload to prevent the same mail from being processed by more than one machine. This approach uses simplified file system primatives available on any software development platform to achieve the necessary synchronization without incurring the variability of the database row lock approach.

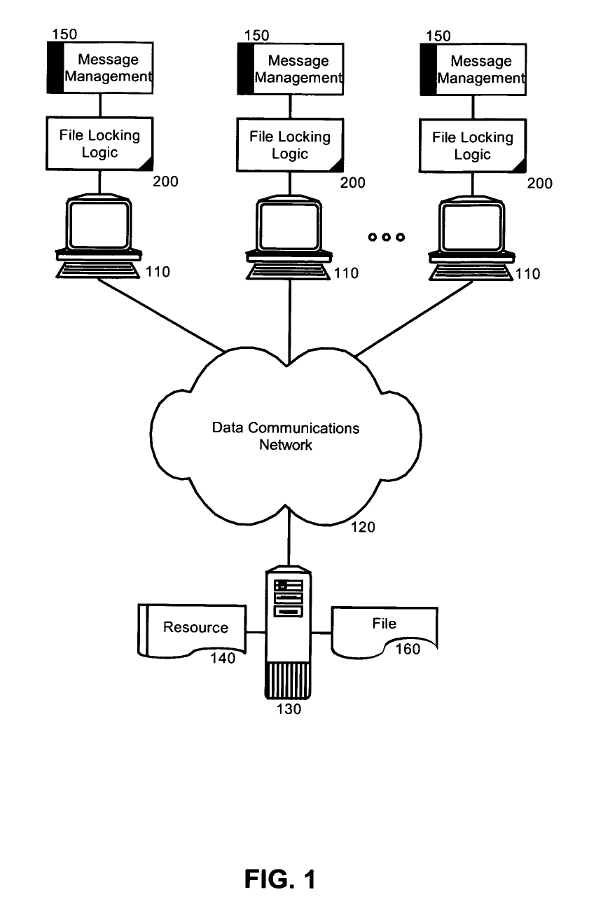

FIG. 1 is a schematic illustration of a data processing system configured for synchronizing access to shared resources in a multi-system mail infrastructure. The system can include a data processing system 130 coupled to one or more mail systems 110 over a data communications network. Each of the mail systems 110 can include a message management application 150 such that the combination of the data processing system 130 and the mail systems 110 can form a multi-system mail management infrastructure.

Notably, each of the mail systems 110 can include file locking logic 200. The file locking logic 200 can include program code enabled to create a locking file 160 with which a file lock can be simulated for accessing a resource 140 in the data processing system 130. Specifically, attempts to delete the file 160, and to create a different file and thereafter to rename the different file to the same name as the file 160 can be monitored. Where successful on both counts, a file lock can be presumed and the resource 140 can be accessed. Where unsuccessful on either count, it can be presumed that another of the mail systems 110 has obtained a lock on the resource 140. Consequently, a wait period can ensue until the process can repeat.

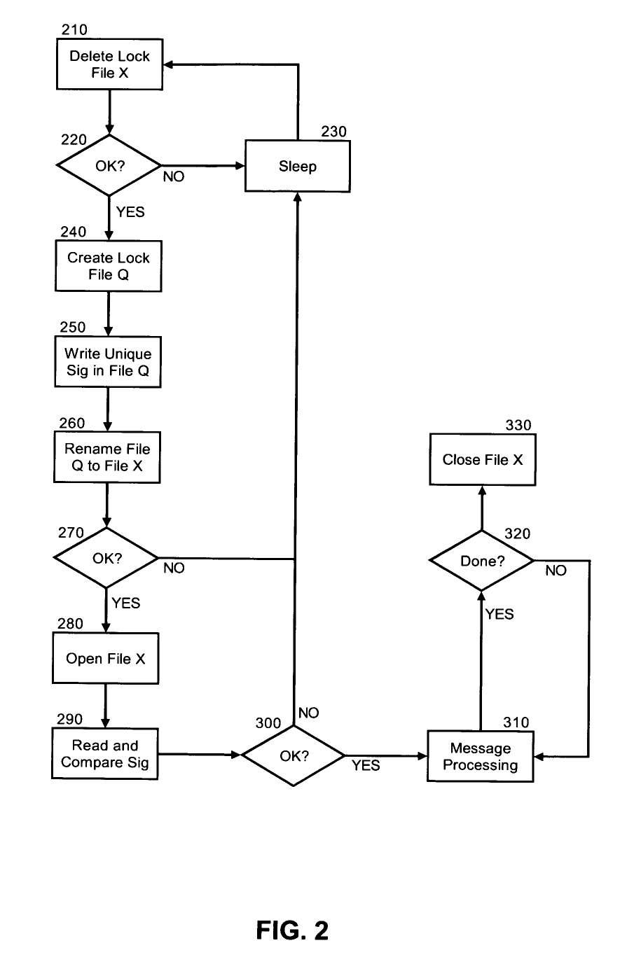

In more specific illustration, FIG. 2 is a flow chart illustrating a process for synchronizing access to shared resources in a multi-system mail infrastructure. Subsequent to obtaining exclusive write access in respect to a primary file, in block 210 an attempt can be set forth to delete the primary file. In decision block 220, if the primary file cannot be deleted, in block 230 the process can wait for a period of time, possibly a random period of time. Subsequently, the process can return through block 210.

Otherwise, if the primary file can be deleted in decision block 220, in block 240 a temporary file can be created having a different name than the primary file. Additionally, in block 250 a unique file signature can be written into the temporary file. Subsequently, in block 260 the temporary file can be renamed to have the name of the primary file. In decision block 270, if the temporary file cannot be renamed, in block 230 the process can wait for a period of time, possibly a random period of time. Subsequently, a new attempt can be set forth to rename the file through block 210.

Otherwise, once the temporary file has been renamed into the primary file, in block 280 the primary file can be opened and the signature can be read in block 290. In decision block 300 it can be determined whether the signature does not match that which had been previously written to the temporary file. If not, in block 230 the process can wait for a period of time, possibly a random period of time. Subsequently, a new attempt can be set forth to delete the primary file and the process can begin anew in block 210. Otherwise, a lock can be considered to have been achieved and message processing can proceed in block 310 while the lock can be maintained for as long as desired. In decision block 320, when the lock is no longer required, in block 330 the primary file can be closed.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

I claim:

1. A method for synchronizing access to shared resources in a multi-system mail infrastructure comprising:
attempting to exclusively access a file; and,
responsive to successfully obtaining access to said file, performing message processing in the multi-system mail infrastructure and releasing exclusive access to said file when concluding said processing.

2. The method of claim 1, wherein said attempting to exclusively access said file comprises attempting to delete a primary file, create a temporary file and rename said temporary file to said primary file.

3. The method of claim 2, wherein said attempting to exclusively access said file further comprises:
writing a unique signature to said temporary file;
opening a renamed version of said temporary file; and,
confirming that said opened renamed version of said temporary file contains said unique signature.

4. The method of claim 1, further comprising, responsive to unsuccessfully failing to obtain access to said file, pausing before re-attempting to exclusively access a file.

5. The method of claim 4, wherein said pausing comprises pausing for a random period of time.

6. A computer program product comprising a computer usable medium having computer usable program code for synchronizing access to shared resources in a multi-system mail infrastructure, said computer program product including:
computer usable program code for attempting to exclusively access a file; and,
computer usable program code for performing in response to successfully obtaining access to said file, message processing in the multi-system mail infrastructure and releasing exclusive access to said file when concluding said processing.

7. The computer program product of claim 6, wherein said computer usable program code for attempting to exclusively access said file comprises computer usable program code for attempting to delete a primary file, create a temporary file and rename said temporary file to said primary file.

8. The computer program product of claim 7, wherein said computer usable program code for attempting to exclusively access said file further comprises:
computer usable program code for writing a unique signature to said temporary file;
computer usable program code for opening a renamed version of said temporary file; and,
computer usable program code for confirming that said opened renamed version of said temporary file contains said unique signature.

9. The computer program product of claim 6, further comprising, computer usable program code for in response to unsuccessfully failing to obtain access to said file, pausing before re-attempting to exclusively access a file.

10. The computer program product of claim 9, wherein said computer usable program code for pausing comprises pausing for a random period of time.
